(19) United States
(12) Patent Application Publication
(10) Pub. No.: US 2021/0174035 A1
(43) Pub. Date: Jun. 10, 2021

(54) METHOD FOR THE DETECTION OF MODIFIED INFORMATION PATTERNS OF A CAPACITIVE INFORMATION CARRIER BY THE USE OF CAPACITIVE DETECTION MEANS

(71) Applicant: Touchcode Technologies, LLC, New York, NY (US)

(72) Inventors: Joachim Keller, Roth (DE); Terrance Z. Kaiserman, Loxahatchee, FL (US); Tayler L. Kaiserman, Brooklyn, NY (US); Michael A. Brody, Philadelphia, PA (US); John Gentile, Montclair, NJ (US); Anthony Gentile, New York, NY (US); Wayne L. Nemeth, Rye, NY (US); Karin Weigelt, Chemnitz (DE); Matthias Foerster, Dresden (DE); Stefanie Funke, Chemnitz (DE)

(73) Assignee: Touchcode Technologies, LLC, New York, NY (US)

(21) Appl. No.: 17/097,514

(22) Filed: Nov. 13, 2020

Related U.S. Application Data
(63) Continuation of application No. 15/570,579, filed on Oct. 30, 2017.

(30) Foreign Application Priority Data
Apr. 30, 2015 (EP) 15165945.5

(51) Int. Cl. G06K 7/08; G06K 19/067; C09D 11/037; C09D 11/101; C09D 11/52

(52) U.S. Cl. CPC G06K 7/081; G06K 19/067; G06K 19/0614; C09D 11/101; C09D 11/52; C09D 11/037

(57) ABSTRACT

The invention relates to a method for the detection of modified information patterns of a capacitive information carrier comprising at least one electrically conductive material forming at least one modifiable electrically conductive pattern, wherein information is encoded within the characteristics of the electrically conductive pattern. The method comprises at least the steps of modifying the characteristics of the electrically conductive pattern and capacitively detecting a second information pattern encoded within the characteristics of the modified electrically conductive pattern. In a further aspect, the invention relates to a capacitive information carrier for use in the method according to the invention and a method for manufacturing a capacitive information carrier for use in the method according to the invention.

The invention relates to a method for the detection of modified information patterns of a capacitive information carrier comprising at least one electrically conductive material forming at least one modifiable electrically conductive pattern, wherein information is encoded within the characteristics of the electrically conductive pattern. The method comprises at least the steps of modifying the characteristics of the electrically conductive pattern and capacitively detecting a second information pattern encoded within the characteristics of the modified electrically conductive pattern. In a further aspect, the invention relates to a capacitive information carrier for use in the method according to the invention and a method for manufacturing a capacitive information carrier for use in the method according to the invention.

### TECHNICAL BACKGROUND OF THE INVENTION

State of the art capacitive information carriers are known comprising an electrically conductive pattern that can be detected by a software on a device comprising a capacitive surface sensor. These conductive patterns applied on a substrate are designed to be static and used to encode one information pattern. Methods to transmit information from state of the art capacitive information carriers are based on the detection of one unmodified information pattern.

In WO 2011/154524, an information carrier and a system for acquiring information is described wherein the information carrier has an electrically conductive touch structure and can be detected by a multi-touch screen. In WO 2010/043422 a data carrier is disclosed, wherein a conductive material is applied patterned on a non-conductive material and can be detected capacitively by the use of an appropriate detection device whose electrode arrays are designed and arranged such that the information pattern can be detected.

Methods of using state of the art information carriers disclose the transmission of one static information pattern. In other words, they are used to decode the information pattern presented by the one conductive pattern.

This mainly limits the amount of information that can be transmitted by a single physical information carrier.

It is therefore the object of the present invention to provide a method and a device that overcomes the disadvantages of the prior art and allows for the transmission of an enriched information content from a capacitive information carrier to a capacitive surface sensor.

### SUMMARY OF THE INVENTION

The objective of the present invention is achieved by the features of the independent claims. Preferred embodiments of the present invention are provided by the dependent claims.

The invention relates to a method for transmitting information from a capacitive information carrier to a capacitive surface sensor comprising the following steps
a) providing a capacitive surface sensor
b) providing a capacitive information carrier, wherein a first information pattern is encoded within the characteristics of an electrically conductive pattern
c) modifying the characteristics of the electrically conductive pattern due to external conditions to encode a second information pattern
d) bringing the capacitive information carrier into contact with a capacitive surface sensor wherein the second information pattern is capacitively detected by the capacitive surface sensor.

In the context of the present invention, it is preferred that an electrically conductive pattern is applied on an electrically non-conductive substrate. The electrically conductive pattern is preferably made from an electrically conductive material. In certain embodiments it may however also be preferred that the electrically conductive pattern refers to a pattern formed by applying a dielectric material on top of a fully electrically conductive layer, wherein the pattern is detectable by a capacitive surface sensor. In such embodiments the electrically conductive pattern is formed by structurally applying at least one dielectric layer on top of the electrically conductive layer. Said dielectric layer may preferably comprise sub-areas that add a structure to the electrically conductive layer. The dielectric pattern masks the electrically conductive layer. Therefore only the electrically conductive sub-areas that are not covered by the dielectric pattern are detected by a capacitive surface sensor. Said remaining electrically conductive sub-areas are preferably used to encode information. In figurative language such embodiments of an electrically conductive pattern may also be described as a negative compared to an information carrier manufactured by the use of a conductive material on top of a non-conductive substrate. The information is encoded within the characteristics of the electrically conductive pattern. Preferably, the term “characteristics of the electrically conductive pattern” encompasses the shape, size, arrangement and/or geometry of said pattern and in particular the conductivity, dimension, shape, number, position and/or arrangement of at least one sub-area and/or the distance of single sub-areas of the pattern to each other. The at least one sub-area may be preferably limited by an outline. In the sense of the invention “information” is encoded within the “characteristics of the electrically conductive pattern” in the sense that the characteristics of the electrically conductive pattern determine the input, which is detected by a capacitive surface sensor. The information encoded within the characteristics of the electrically conductive pattern therefore preferably refers to the information detected by a capacitive surface sensor when the information carrier is brought into contact with a capacitive surface sensor. Since the information is preferably encoded within the characteristics of the electrically conductive pattern, the term “information pattern” is preferably used for information encoded within the electrically conductive pattern that is detected by the capacitive surface sensor. In the sense of the invention the term information pattern, information, code or code pattern are preferably used synonymous.

The term “surface sensor” or “capacitive surface sensor” preferably relates to any kind of detection means which can be brought into contact with a capacitive information carrier and are suited to recognize electrically conductive patterns and in particular the characteristics of the electrically conductive pattern. For example, the information carrier may be placed on top of a capacitive surface or inserted into a slit or any kind of reception device of a surface sensor. The surface sensor may be specifically adapted for the detection of the conductive pattern according to the present invention. In terms of the present invention it may therefore be preferred to use a capacitive surface sensor whose electrode arrays are geometrically arranged so that the characteristics of the at least one sub-area can be detected surprisingly well.

In the context of the present invention, the inventors have further found that it is possible not only to detect the presence of electrically conductive material, but also to determine the properties of the electrically conductive material more in detail. It came as a surprise that the electrical resistance of the electrically conductive material forming the pattern may be evaluated and/or estimated by capacitive surface sensors using various frequencies of the input signal.

The electrically conductive pattern is preferably detected by capacitive reading devices which are selected from a group of capacitive surface sensors. It may be preferred to detect the electrically conductive pattern by surface sensors whose electrode arrangement is geometrically arranged to decode the properties of the electrically conductive pattern. For other purposes it may however be preferred to use capacitive surface sensors comprising capacitive touchscreens and/or touchpads incorporated in devices, selected from a group of smartphones, mobile phones, displays, tablet PCs, tablet notebooks, touchpad devices, graphic tablets, televisions, PDAs, MP3 players and trackpads.

In the context of the invention the term “device” and “device comprising a capacitive surface sensor” are preferably used synonymously.

In the context of the presented invention bringing the information carrier into contact with the device preferably means that the capacitive information carrier is brought close to the surface sensor of the device, preferably in a distance that the capacitive surface sensor detects changes in capacitance due to the presence of the conductive pattern of the information carrier. It may be particularly preferred that the capacitive information carrier is at least partially, more preferably over a substantial area of the conductive pattern, in a direct contact with the capacitive surface sensor of the device.

In the sense of the present invention “modifying the characteristics of the electrically conductive pattern” results in a modified conductive pattern, such that a second information pattern can be detected by a capacitive surface sensor after the modification. The second information pattern is different from the first information pattern detectable by a capacitive surface sensor prior to the modification. Said modification may activate a new conductive pattern, deactivates at least a part of an existing conductive pattern or destroys a conductive pattern completely. The terms modify or change as well as modification or change are preferably used synonymously.

In terms of activating or deactivating at least a part of a conductive pattern, adding conductive elements or combining two existing conductive pattern, the capacitive surface sensor will detect the modified conductive pattern that is different from the original conductive pattern. The unmodified conductive pattern may for instance trigger a first action upon detection, whereas the modified conductive pattern may trigger a second action upon detection by a device comprising the surface sensor.

It may also be preferred that the characteristics of the electrically conductive pattern are modified in a way that the electrically conductive pattern is destroyed completely. In this case the capacitive information carrier does not longer encode a conductive pattern that can trigger any action on the device. In other words, although a capacitive reading device may be able to detect signals of remaining parts of the electrically conductive pattern, these parts do no longer encode a second information pattern that will trigger an action on the device.

Advantageously, modifying the characteristics of the electrically conductive pattern allows to encode for more than just one information pattern using a single information carrier. Thereby the information content transmitted from one physical information carrier can be surprisingly enriched and a number of new applications are possible. For instance, it is possible to limit the usage of an information carrier by the method according to the invention to a one-time usage. For instance a first information pattern may allow for an authorization for a certain action. After the modification, the electrically conductive pattern encodes for a second information pattern for which an authorization may be denied. Moreover, the method according to the invention increases the number of information patterns available from a single information carrier. In terms of the present invention it is possible to create a new information pattern based on the same physical information carrier. Whereas state of the art information carriers and methods are limited to encode the information pattern present on the information carrier, an electrically conductive pattern in the sense of the present invention can be used to encode multiple information patterns. In other words, the capacitive information carrier as described herein may also be described as an information carrier carrying multiple information patterns. Therefore, new information patterns can be easily created by the using the same physical information carrier.

It further came as a surprise that a change can be caused by numerous options, enabling for a broad range of different applications. Compared to state of the art information carriers and methods this allows not only for more information patterns and further applications such as one-time limits. It also provides a much more interactive, user-friendly and easy handling of the capacitive information carrier. Compared to static state of the art information carriers a user is for example able to easily modify a conductive pattern which leads to changed information pattern that is accessible.

As an example, information A according to an electrically conductive pattern A may be encoded within the information carrier. This conductive pattern A may undergo a change, e.g. due to folding or mechanical impact on the information carrier. This folding or mechanical input causes a change in the appearance of the electrically conductive pattern so that a modified electrically conductive pattern B is generated. In other words, at least a part of the information pattern A is deactivated. The new conductive pattern B is preferably related to an information B which is decoded after the change in external condition from a first state A (information pattern A) to a second state B (information pattern B).

In a preferred embodiment the invention further relates to a method for transmitting information from a capacitive information carrier to a capacitive surface sensor comprising the following steps
a) providing a capacitive surface sensor
b) providing a capacitive information carrier wherein information is encoded within the characteristics of an electrically conductive pattern
c) bringing the capacitive information carrier into contact with a capacitive surface sensor wherein a first information pattern is capacitively detected d) modifying the characteristics of the electrically conductive pattern due to external conditions
e) bringing the capacitive information carrier into contact with a capacitive surface sensor wherein a second information pattern is capacitively detected by the capacitive surface sensor.

In terms of the present invention a modification of the characteristics of the electrically conductive pattern can be caused by various external conditions. In the sense of the invention the term “external condition” preferably refers to any impact on the information carrier suited to result in a modification of the electrically conductive pattern.

In a preferred embodiment of the invention the characteristics of the electrically conductive pattern are modified by external conditions selected from a group of mechanical impact; electric, electromagnetic and/or magnetic impact; environmental impact; chemical impact and/or addition of electrically conductive material.

It was totally surprising that a method can be provided which makes use of information carriers comprising an electrically conductive pattern that may be modified by external conditions. Advantageously, this gives way to provide several different states of one information pattern based on one the conductive pattern and/or parts of said pattern of the same physical information carrier.

In the sense of the invention a “mechanical impact” preferably refers to a modification of the electrically conductive pattern by applying a force onto the electrically conductive pattern.

In one embodiment of the present invention it is preferred to change the characteristics of the electrically conductive pattern by a mechanical impact, in particular by abrasion and/or scratching; separating, cutting, perforation and/or punching; velocity, acceleration and/or shock; physical tampering and/or pressure change.

It may be preferred to change the characteristics of the electrically conductive pattern by scratching or abrading at least a part of the pattern. In regard to an electrically conductive material applied to a non-conductive substrate this might for example be realized by the use of a coin, a finger nail or a knife. A person skilled in the art knows how to remove at least a part of an applied material from a substrate. In terms of the invention means to scratch or abrade a part of the conductive material are not limited to the above mentioned, a person skilled in the art knows that any methods and materials which are suited to remove an applied layer from a substrate can be used. In terms of abrasion and/or scratching, at least a part of the conductive pattern is removed which leads to the modification of the conductive pattern. Said modification causes a new information pattern, i.e. a second information pattern is encoded, whereas it may also be preferred to destroy the conductive pattern completely. The invention therefore also encompasses information carriers, which are particularly suited for a scratching or abrasion of the electrically conductive pattern. For instance, the invention may encompass the provision of an information carrier with a particularly thin electrically conductive pattern without a protection layer on top of the conductive pattern, such that it may be easily modified by scratching and/or abrasion.

If the conductive pattern is e.g. applied to an admission ticket, a first detectable information pattern may be used to grant access to a VIP area whereas scratching the conductive pattern may remove at least a part of the conductive pattern thereby generating a second conductive pattern. If detected again, a second information pattern may allow for a different authorization level and deny access to a VIP area.

In another preferred embodiment, the characteristics of the electrically conductive pattern may be changed by separating, cutting, perforation and/or punching. It may be preferred to cut an existing conductive pattern by the use of claws. In another preferred embodiment it may be preferred to separate a conductive pattern by a perforation line, e.g. if the conductive pattern is applied on a flat substrate material as for example used for trading cards, discount cards or response tickets. Prior to the perforation, the first information pattern of a trading card may be used to trigger an action, e.g. such as activating a level. If the card is perforated, at least one of the separated parts can be used to decode a second information pattern which will trigger another action, e.g. activate a weapon. In yet another embodiment it may be preferred to punch the conductive pattern so at least a part of it will be removed or the conductive pattern may be destroyed completely.

In another preferred embodiment the information carrier may be used as a lid and/or top cover of a food or beverage container which is preferably modified by a mechanical impact. In one embodiment beverage containers are used into brewing machines to automatically prepare a drink based on the characteristics of said container. If a conductive pattern is applied on a lid or top cover, a first information may activate brewing instructions related to said container. During the preparation, the lid is punctured to mix the ingredients within the container with further ingredients. Said puncture preferably destroys the conductive pattern, so if the container is placed again into the brewing machine, no information pattern or an information pattern that does not authorize the brewing process will be detected. In other words, the brewing machine will not prepare a drink for a container that has been already used, which means the use of the container can be limited to a one-time application.

As a further example, an electrically conductive pattern may be attached to a package and modified by opening the packaging. This can e.g. be achieved by applying the electrically conductive pattern partly on the lid of the packaging and partly on the remaining surfaces of the packaging. The first information pattern may advantageously correspond to the un-opened packaging and represents an information with regard thereto, e.g. the original filling quantity etc. When the lid is removed or bent away from its original position, the electrically conductive pattern preferably changes due to the missing parts of the original first electrically conductive pattern and advantageously a second information pattern is obtained. In the context of this example, it is preferred that the removal or bending away of the lid corresponds to the modification of the conductive pattern caused mechanically. Preferably, the second information pattern represents an information with regard to the opened packaging, e.g. a recipe or preparation services.

It may further be preferred to modify a conductive pattern by moving it with a certain velocity, acceleration and/or shock. A conductive pattern may for example be modified by an external force applied to the information carrier which causes a change in the conductive pattern, wherein said change may lead to the destruction of at least a part of the conductive pattern. Said change may dependent on the velocity of the applied force.

For other purposes it may also be preferred that a modification is caused by tampering. In terms of the present invention the characteristics of the conductive pattern, e.g. the overall shape and/or arrangement, may be changed. Tampering may e.g. be executed by bending, rolling or folding a conductive pattern applied to a flat substrate or by opening a package comprising a conductive pattern.

In yet another preferred embodiment a change in pressure deforms at least a part of the conductive pattern, e.g. if the pressure applied to a capacitive information carrier exceeds a certain value which modifies a part or the whole conductive pattern.

It was totally surprising that a method for the use of a capacitive information carrier can be provided wherein the use can be limited to a defined number. It further came as a surprise that the capacitive information carrier may be used for anti-tampering applications, e.g. for pharmaceutical, cosmetics or food packaging. For said preferred embodiment, parts of the conductive pattern are removed or modified by opening a package, thereby causing a modified conductive pattern. Advantageously it is not possible to use the modified package for counterfeited contents. Within said example, the first information pattern is used to decode the packaging as original package whereas the second information pattern is used to decode another content. In terms of security this might be e.g. “package has been already opened” or “used package” or “Attention: this package probably contains faked contents”.

In another preferred embodiment of the invention the characteristics of the conductive pattern are modified by an electric, electromagnetic or magnetic impact, preferably by the use of laser radiation; electromagnetic radiation such as ultraviolet (UV) radiation, infrared (IR) radiation, radiofrequency (RF) radiation, microwave or other electromagnetic radiation; or the application of electrostatic fields and/or electrodynamic fields.

In terms of the present invention an electrically conductive pattern may be modified by laser radiation. The electrically conductive pattern can be removed partly by laser ablation or the conductivity of said pattern may be advantageously changed by the laser radiation.

For other purposes it is preferred to change the properties of the electrically conductive pattern by electromagnetic radiation such as ultraviolet (UV) radiation, infrared (IR) radiation, radiofrequency (RF) radiation, microwave or other electromagnetic radiation. Electromagnetic radiation is the radiant energy released by certain electromagnetic processes. Classically, electromagnetic radiation consists of electromagnetic waves, which are synchronized oscillations of electric and magnetic fields. Electromagnetic waves are produced whenever charged particles are accelerated, and these waves can subsequently interact with any charged particles. Due to this, the interaction of electromagnetic waves with materials depends on their frequency which may vary over many orders of magnitude. At low frequencies, the energy of the photons is too low to trigger chemical processes. At higher frequencies, the field of ionizing radiation, a single photon can change the properties of molecules or atoms, in particular remove electrons.

In terms of the present invention it is therefore preferred to use electromagnetic radiations, e.g. UV or IR radiation, to impact the properties of a conductive pattern. Electromagnetic radiation may cause a change in the conductivity of the conductive pattern. The modified conductivity of the electrically conductive pattern is advantageously detectable by a capacitive surface sensor. In other words, the electrically conductive pattern presents a first information pattern prior to the impact of the electromagnetic waves and a second modified information pattern afterwards. It was surprising that such an efficient and fast modification of the electrically conductive pattern is possible.

In another preferred embodiment UV radiation may be preferably used to activate a code pattern. It may be preferred that an information carrier is provided for which the electrically conductive pattern is manufactured from UV curable ink. It may be further preferred that the UV curable ink is not cured during the printing, therefore the unmodified conductive pattern is not readable by a capacitive surface sensor and the first information pattern does not represent an initial functionality. However, after exposure to direct sun light containing UV light the material of the conductive pattern obtains a certain level of conductivity and the second information pattern may consequently be detected by a capacitive surface sensor. A slow curing or drying of the conductive ink could also be realized by warm air and/or IR impact.

An electric field is a vector field that associates to each point in space the Coulomb force experienced by a unit electric charge. An electrostatic field does not change over time whereas an electrodynamic field changes over time. Electric fields impact the electric charges which are present in the electrical field. Electrodynamic fields may be preferably differentiated between high and low frequency fields. In terms of the present invention a change in the electrical field may change the characteristics of the electrically conductive pattern, in particular the conductivity of the pattern.

In a further embodiment of the invention, the characteristics of the electrically conductive pattern are modified over time by an environmental impact by a change in temperature, humidity and or/moisture.

With regard to a modification of the conductive pattern caused by temperature, it is preferred that the conductive material and/or the electrically conductive pattern may change either temporarily or permanently due to a change in temperature. This may e.g. depend on the reversibility of the change of the characteristics of the electrically conductive material. The invention therefore also encompasses the provision of information carriers for the method in which the electrically conductive pattern is made of an electrically conductive material which characteristics are modified upon a change of temperature, e.g. upon a raise of temperature from room temperature to higher than 40° C., preferably higher than 60° C.

In a further exemplary application of the present invention, it is preferred to detect and/or estimate the temperature of a drink. As an example, the bottle cap of a beverage container may be flat, as long as the beverage bottle is stored in a fridge. Due to increasing temperature, the cap will preferably dome and may no longer be placed flat on a capacitive surface sensor. Preferably, the underlying principle is the mechanical deformation of the substrate material due to the exerted pressure.

In another preferred embodiment a conductive pattern is preferably modified over time by humidity and/or moisture. If a capacitive information carrier is e.g. applied on a lid/and or top cover or attached as a label to a food or beverage container, the electrically conductive pattern may preferably be modified by moisture. Before such a container comprising an electrically conductive pattern is used in a beverage or food preparation machine, the electrically conductive pattern presents a first information pattern. If said container has been used within the preparation machine, the moisture will destroy at least a part of the electrically conductive pattern. This modifies the characteristics of the conductive pattern, which is preferably detected as a second information pattern if the remaining part of the conductive pattern is still detectable. It may also be preferred that the complete conductive pattern is destroyed, so no information pattern is detectable after the modification.

In the sense of the invention the “chemical impact” preferably refers to bringing the electrically conductive pattern into contact with a chemically reactive substance.

In a preferred embodiment the characteristics of the electrically conductive pattern may be modified by chemical reactions with a substance, preferably with an acidic or alkaline solution. In terms of the present invention, the conductive pattern may for example be influenced by the pH value of another material. PH is defined as a numeric scale used to specify the acidity or basicity of a solution that is solved in water. Solutions with a pH less than 7 are acidic solutions and solutions with a pH greater than 7 are alkaline solutions.

In terms of the present invention a conductive pattern may be modified by the influence of an acid, e.g. by hydrochloric acid. If for example a hydrochloric acid may be applied to a conductive material such as aluminum, the hydrochloric acid advantageously dissolves the aluminum which leads to a change of the conductivity. If a hydrochloric acid is applied to a conductive foil, e.g. a cold foil, both materials react, which leads to a change of the characteristics of the cold foil. By this method the conductive pattern can be modified in a particularly effective and precise manner.

In yet another preferred embodiment the conductive pattern may be modified by an addition of electrically conductive material selected from a group of conductive colors, pencils; conductive bridges and or conductive foils and/or inks.

In said preferred embodiment, a conductive bridge may establish a connection between at least two parts of a conductive pattern or two conductive patterns. It may be preferred to connect at least two conductive patterns by an electrically conductive bridge, which is suited to connect two separated electrically conductive patterns. As an example, two playing figurines may be put together to create an only digitally available third character. As a second example, two trading cards may be combined to obtain a limited weapon and/or grant access to a hidden level in a computer and/or video game.

It may also be advantageous to complete a conductive pattern using a conductive pencil and/or color. In said embodiment, the conductive patterns are not connected by the use of a predetermined conductive element. Instead, a connection is added by the use of electrically conductive colors or pencils. This allows for a flexible use and increases the user interaction. It was surprising that by using such low cost means multiple information patterns may easily be created.

For other purposes it may also be preferred that electrically conductive patterns are connected by the electrical potential of a human user that touches at least a part of each conductive pattern.

In a third preferred embodiment an existing code pattern may also be modified by adding further conductive parts, e.g. by printing them on the non-conductive substrate using a suited printing process, e.g. ink jet. This advantageously allows for an extension of existing code patterns to create a new code pattern after the modification.

Additionally, new code patterns may be created and obtained by a product interaction, e.g. a package having different side panels whereas a conductive pattern is applied on at least two parts of the package. By said embodiment, at least three different states of the information carrier can be established, i.e. a first state in which the pattern on a first side panel of a package is detected, a second state in which a pattern on a second side panel of a package is detected and a third state in which the combination of the two patterns present on the different sides of the package is detected, forming a third information pattern. As can be seen from this example, the application and the method of using the information carrier, i.e. the way in which the information carrier is placed on top of a capacitive surface sensor, can make a difference on the outcome of the detection and therefore be referred to as an external condition which is imposed on the information carrier and/or the electrically conductive material forming the electrically conductive pattern.

In another preferred embodiment of the invention a modification of the electrically conductive pattern may be caused by a combination of two or more external conditions. It may for example be preferred to combine a mechanical impact with impacts based on the environment of a conductive pattern. An application example may be a conductive pattern on a top cover for a beverage or food container. In addition to the impact of moisture which will at least damage the electrically conductive pattern, the complete destruction can be ensured by puncturing the top cover as soon as the container is used in a preparation machine.

In yet another embodiment it may also be preferred to combine an impact of electromagnetic radiation and the addition of an electrically conductive material. At least two parts of one electrically conductive pattern or two conductive patterns may be printed by the use of an UV curable ink. After the conductive pattern is exposed to UV light the conductive material reaches a sufficient conductivity such that it can be detected by a capacitive surface sensor. Therefore, the single conductive pattern may represent a first and a second information pattern, wherein a third information pattern can be created by an addition of conductive material, e.g. by adding a conductive bridge, using a conductive pencil or by a human user touching at least a part of each conductive pattern and thereby enabling an electrical connection between both patterns.

In the sense of the invention any combinations of the external conditions may be suited to modify the characteristics of the electrically conductive pattern. In terms of the present invention the conditions selected may preferably depend on the properties of the non-conductive and conductive materials, the application, i.e. the particular use case, or on the capacitive surface sensor, which is used to detect the information patterns.

In another preferred embodiment of the invention, the electrically conductive pattern is made of or comprises two or more different conductive materials.

As an example, the invention may relate to an information carrier characterized in that two or more different conductive materials are used comprising different mechanical properties, e.g. tensile strength, hardness, ductility, brittleness etc. Thus, electrically conductive patterns may be realized that are modified by mechanical impacts, e.g. by folding, rolling, scratching or any other mechanical impact. In one embodiment the electrically conductive pattern may consist of a conductive foil and a conductive ink. Due to the different ductility of both conductive materials a change in the electrically conductive pattern may be caused by a mechanical impact to the conductive foil, as this material is affected by bending and rolling, whereas the conductive ink is more flexible and will not be influenced by bending or rolling the capacitive information carrier. Therefore, the part of the conductive pattern realized by the conductive foil becomes inactive whereas the part manufactured by the conductive ink remains, presenting a second information pattern.

As another example, the information carrier according to the present invention may comprise two or more conductive materials with different thermal coefficient of resistance. In the sense of the invention the thermal coefficient of resistance refers to the change of electrical resistance of a conductive material with respect to the temperature. In this preferred embodiment of the invention, a temperature decrease or increase may therefore change the conductivity of the conductive pattern and thus information encoded in the electrically conductive pattern. Advantageously, different information patterns may be detected depending on the temperature.

As another example, the invention may relate to an information carrier comprising two or more conductive materials, wherein one of the at least two electrically conductive materials is being soluble in water or any other solvent. Examples of an electrically conductive material that is soluble in water is an electrolyte based pattern, whereas e.g. aluminum would not be soluble in water. Thus, a conductive pattern may be provided wherein one part of the pattern is based on an electrolyte, e.g. made of a salt, whereas another part may not be made of an electrolyte. Advantageously only the electrolyte based part of the conductive pattern will be modified, e.g. removed, by an impact of water, moisture and/or humidity. Said external condition preferably modifies the information encoded, in other words a second information pattern is represented after the conductive pattern has been changed.

In yet another embodiment it may also be preferred to use two conductive materials that can be decoded as two different information pattern prior to any modification, e.g. a conductive pattern A based on an electrolyte and a conductive pattern B based on a silver ink. By the use of a dedicated reading device, both can be detected as single information patterns by their conductivity, but it may also be preferred to detected them as one information pattern (C) on a capacitive touchscreen. In a second step, both patterns are modified by an external condition. That means, the modified conductive pattern A will be detected as an information pattern D, the modified conductive pattern B will be detected as an information pattern E and the modified conductive pattern C as an information pattern F. It was totally surprising that the invention allows for the detection of six different information patterns based on one single capacitive information carrier. This surprisingly increases the number of different information patterns detectable by a device and allows for complex applications.

As another example, the information carrier according to the present invention may comprise three or more conductive materials with different properties. The electrically conductive pattern may for example be made of conductive ink, transfer foil and an electrolyte, so that multiple states may be realized by water impact, mechanical impact, environmental impact or any other conceivable impact to which the information carrier and the electrically conductive pattern thereon are sensitive. Advantageously, by combining a certain number of different electrically conductive materials which are sensitive to different external conditions, a large number of different states of the information carrier, in particular for the conductive pattern, can be provided, which gives way for the use of the information carrier to encode a large set of different information patterns.

In terms of the present invention, it is preferred that the electrically conductive pattern comprises at least one sub-area that presents the information pattern which is capacitively detected. The at least one sub-area is preferably limited by an outline and preferably forms a circle, a rectangle, a triangle or any other geometrical shape that is suited to be detected by a capacitive surface sensor. Even indeterminate forms such as free-hand shapes or randomly or pseudo-randomly generated structures may be preferred. It is further preferred that at least one sub-area forms the conductive pattern wherein the information is encoded within the shape, size, arrangement and/or geometry of the electrically conductive pattern and in particular by the characteristics of the sub-area, advantageously by the conductivity, dimension, shape, number, position and/or arrangement of at least one sub-area and/or the distance of single sub-areas to each other.

In the context of the present invention, it is preferred that the aforementioned characteristics of the electrically conductive pattern are modified due to external conditions which causes a modification in the conductive pattern of the capacitive information carrier and thus the information detected by a capacitive surface sensor.

In one preferred embodiment of the invention, the sub-areas of the conductive pattern are completely and/or partly filled printed. In the context of the present invention, the term “partly filled” relates to a coverage of the area of a sub-area of less than 100%. It is preferred that the sub-areas are enclosed by an outline. The coverage of the area preferably refers to the ratio of the area of the conductive material of the sub-area to the area enclosed by said outline. In a preferred embodiment of a partially filled sub-area, the sub-area may comprise rays, lines and/or curves or any combination, honeycomb and/or grid patterns, description fields and/or any combination thereof. Preferably, these elements may be arranged in any regular or irregular way. It came as a surprise that sub-areas may also be sufficiently well recognized by a capacitive surface sensor if their coverage is less than 100%. By this, electrically conductive material may be saved so that manufacturing costs can advantageously be reduced.

For some purposes it may be preferred that the sub-areas are shaped identically. In terms of the present invention that means that all sub-areas have the same dimensions and shape. For other purposes it may be preferred that at least one sub-area differs from another sub-area. It may also be preferred that sub-areas are connected to each other whereas it may be preferred that only some sub-areas are connected whereas it may also be preferred that no sub-area is connected to another sub-area.

In a preferred embodiment of the invention, the detection means are selected from a group comprising capacitive surface sensors selected from a group of capacitive surface sensors who's electrodes arrangement is geometrically arranged to decode the characteristics of the electrically conductive pattern and/or capacitive surface sensors comprising capacitive touchscreens and/or touchpads integrated into devices, selected from a group of smartphones, mobile phones, displays, tablet PCs, tablet notebooks, touchpad devices, graphic tablets, televisions, PDAs, MP3 players and trackpads.

The term capacitive touchscreen preferably refers to a detection means comprising a display, which is suited to recognize touches, i.e. a touch sensitive display. Preferably, the touch screen comprises an active circuit, which may comprise a grid of electrodes. The purpose of a touch screen is in particular the detection of conductive objects and their position on the surface of the touch screen. By bringing into contact a conductive object with the surface of a touch screen, a change of an electronic parameter is detected, which may include a change in the electric currents or voltages at the grid of electrodes. Thereby a touch controller detects a change in capacitance in its vicinity.

If the capacitive information carrier is intended to be used on a capacitive touchscreen, an external electrical potential needs to be applied to the electrically conductive pattern. This is due to the common working principle of capacitive touchscreens that detect a change in capacitance as soon as a conductive object touches the touchscreen or is at least in a close contact to said touch screen. This changes the electrical field at the intersection point between a driving and a sensing electrode. In figurative language it can be described as charges which are stolen. This is detected as a so called touch event by a touch controller.

In such embodiments it is preferred that at least two sub-areas of the electrically conductive pattern are connected among each other by connecting lines. To detect the capacitive information carrier on a touchscreen it is preferred that an information carrier is brought into close contact with said touchscreen and touched by a conductive object, preferably by a user. In said embodiment, the entire conductive pattern, i.e. the sub-areas and the connecting lines, are preferably set onto the potential of the user. In other words, an external potential is applied to the electrically conductive pattern. As the sub-areas are preferably connected by connecting lines, the potential is equally distributed to all sub-areas. In said embodiment it is preferred that the conductive object touches the conductive pattern at one sub-area. This enables the touchscreen to sense a change in capacitance at the positions of the sub-areas on the touch screen. Such changes are detected by the capacitive touch screen and generate touch events. Due to the preferred embodiment, the touch events triggered by the sub-areas are used to decode the conductive pattern, more in particular the information pattern presented by the conductive pattern.

In said embodiment, the sub-areas which are used to trigger touch events are preferably similar to finger tips, i.e. the sub-areas preferably replicate the size and/or shape of fingertips. When brought into contact with a touch screen the preferred sub-areas trigger a touch event and thus may execute an input on a touch screen like a finger tip. To this end preferably, the sub-areas may comprise any conceivable geometric form having dimensions of 1 to 20 mm, preferably 4 to 15 mm and more preferably 6 to 10 mm. The term “dimension” refers to characteristic lengths of the form and/or shape of the sub-area. If, e.g., the sub-area has a circular shape, the term “dimension” will preferably refer to the diameter of the circular area of the sub-area. If, e.g., the sub-area has a square shape, the term “dimension” will preferably refer to the side length of the square forming the sub-area. It is preferred that the square of the dimension is a good estimation for the area of a single sub-area, i.e. the area of a single sub-area will preferably be in the range of 1 to 400 mm², preferably 16 to 225 mm² and more preferably 36 to 100 mm². Particularly preferred shapes for the sub-areas to be detected by touch screen are a circular shape, a rectangular shape or an elliptical shape with a dimension of 1 to 20 mm preferably 4 to 15 mm and more preferably 6 to 10 mm.

It is further preferred that the connecting lines have an essentially rectangular area with broad sides and long sides, wherein the ratio of the broad sides and the long sides may preferably be in a range of 1:500 to 1:5, more preferably 1:100 to 1:10, most preferably 1:50 to 1:10. Due to their layout and ratio, connecting lines advantageously do not trigger any touch events on a touch screen. To limit deviations and distortions which may be caused by their influence it is preferred to provide connecting lines that cover as little area as possible. Tests have shown that a ratio of 1:50 to 1:10 between the broad sides and the long sides of the essentially rectangular sub areas of the connecting lines leads to a minimal influence on the position recognition of the sub-areas. Advantageously the connecting lines may serve as a galvanic connection between two sub-areas or between a sub-area and a contact area.

In another preferred embodiment the conductive pattern comprises a contact area. Said contact area is preferably connected by at least one connecting line to at least one sub-area of the conductive pattern. Within said embodiment, the contact area allows to couple in extraneous capacitances that are not a constituent part of the electrically conductive pattern. By virtue of the electrically connection established between the sub-areas of the conductive pattern and the contact area, the change in capacitance caused by a touch of the contact area may evenly be distributed within the electrically conductive pattern so that in particular the sub-areas are set on the level of the external capacitance, which may e.g. be a human finger or a capacitive stylus. Compared to the embodiment describe above, wherein external potential is transferred by a touch of a sub-area as soon as the information carrier is in contact with a touchscreen, a contact area is preferably not placed on the touchscreen.

It is preferred that the contact area may comprise any conceivably shape, e.g. geometric shapes, such as a square, rectangle, triangle, oval, elliptical, circular, n-edge, and/or non-geometric freehand forms of any shape. Preferably, the contact area comprises a specific area whose outline is determined by a solid or a virtual line. The size of the contact area is preferably at least 1 cm². It is preferred that the contact area is completely filled with the electrically conductive material, but it may, for certain purposes, also be preferred that the contact area is not completely filled, which means in the sense of the present invention that the coverage of the contact area may be less than 100%. In this preferred embodiment, the contact area may comprise rays, lines and/or curves or any combination, honeycomb and/or grid patterns, completely printed sub areas, description fields and/or any combination thereof. Preferably, these elements may be arranged in any regular or irregular way. It is further preferred that the contact area is easily accessible for a conductive object or a user.

The use of touchscreen devices as a capacitive detection device advantageously allows for mass market applications, since devices using a touchscreen are widely-spread in the market, e.g. smartphones or tablets.

In yet another preferred embodiment it may also be preferred to detect a capacitive information carrier by the use of two detection devices. As an example, an original conductive pattern can be detected by any capacitive touch screen, wherein a modified conductive pattern caused by external conditions is preferably only detectable by a dedicated surface sensor. This may e.g. be achieved by a mechanical impact which separates the conductive pattern into at least two parts wherein the remaining parts do not generate touch events on a touch screen, but can only be detected by a dedicated reading device. This may for example be realized by disconnecting the sub-areas of a conductive pattern designed for a touch screen, in particular by destroying the connecting lines. By said change, the sub-areas are no longer connected, whereby the conductive pattern cannot be detected anymore by a capacitive touchscreen and no information pattern can be transmitted to the touch screen.

It was totally surprising that the invention described herein thereby allows for applications which may combine marketing and high-security applications. A first information pattern may e.g. be used to grant access to product information on a user's touchscreen device whereas a dedicated reading device allows for access to a restricted area.

It is preferred that the information carrier may be flat or spatial. The term “flat” preferably refers to a card-like information carrier, whereas the term spatial preferably refers to a 3-dimensional object to which the information carrier is attached and/or which may serve as electrically non-conductive substrate itself. It is preferred that any object which can be equipped with a printed conductive material and/or contain a conductive material may be used for this purpose.

In one preferred embodiment of the invention, the capacitive information carrier is connected to an object or the object itself serves as the substrate for the electrically conductive material. The above mentioned information carrier connected to a beverage or food container may preferably serve as an example of an information carrier which is connected to an object, wherein the container is the object in question. It may, for other purposes, also be preferred if an object itself serves as a substrate for the electrically conductive material, e.g. the liquids inside a bottle. Preferably, an object may be any conceivable 3 dimensional object, thing or matter which is suited to be connected to an information bearing medium or which may serve as a substrate for such an information carrier.

In another preferred embodiment of the invention, the object comprises at least a first and a second plane surface wherein the electrically conductive pattern is arranged on two surfaces. By said embodiment, at least three different states of the information carrier can be established, i.e. a first state in which the pattern on a first side panel of a package is detected, a second state in which a pattern on a second side panel of a package is detected and a third state in which the combination of the two patterns present on the different sides of the package is detected, forming a third information pattern. As can be seen from this example, the application and the method of using the information carrier, i.e. the way in which the information carrier is placed on top of a capacitive surface sensor, can make a difference on the outcome of the detection and therefore be referred to as an “external condition” which is imposed on the information carrier and/or the electrically conductive material forming the electrically conductive pattern.

If the capacitive information carrier is intended to be used on a capacitive touchscreen, it is preferred that the sub-areas are arranged on a first plane surface of the object whereas the contact area is arranged on a second plane surface of the object, being preferably connected by connecting lines which are preferably present on both plane surfaces. In this preferred embodiment, the plane surface of the object carrying the sub-areas is preferably placed on top of the capacitive surface sensor whereas the contact area can be directed to a human user of the information carrier enabling for an easy handling and enhanced accessibility of the contact area. By said preferred embodiment, the contact area is not placed and/or arranged on top of the detection means, e.g. the touch screen. A change within the conductive pattern may be preferably caused by using, i.e. opening, the package. This leads to a destruction of the connecting lines which means that the sub-areas forming the conductive pattern are no longer detectable by a capacitive touch screen. Since they are no longer connected to the contact area it is not possible to couple in an external potential which is needed to detect the conductive pattern on a touch screen. In one preferred embodiment the sub-areas may be still capacitively detected by a dedicated surface sensor.

The invention further relates to a method to manufacture a capacitive information carrier, comprising the following steps:
a. providing a non-conductive substrate
b. providing an electrically conductive material, selected from a group of metal particles, nanoparticles, in particular silver, gold, cooper, and/or aluminum, electrically conductive particles, in particular carbon black, graphite, graphene, ATO (antimony tin oxide), electrically conductive polymer layer, in particular Pedot, PANI (polyaniline), polyacetylene, polypyrrole, polythiophene, pentacene or any combination thereof
c. applying the electrically conductive material in a structured manner by printing processes and/or foil transfer methods to create a conductive pattern.

It is preferred that the electrically non-conductive substrate consists of a non-conductive material, in particular paper, cardboard, plastic, a wood based material, composites, glass, ceramic, textile, leather or any combination thereof. These materials have shown to be particularly suitable for the production of information carriers according to the present invention as their being nonconductive generates a large capacitive contrast between the sub areas of the electrically conductive pattern and the substrate in that sense that the capacitive detection of the position of the sub areas is enhanced.

It may be preferred to use electrically conductive materials selected from a group comprising but not limited to electrically conductive inks; metal particles or nanoparticles; electrically conductive particles, in particular carbon black, graphite, graphene, ATO (antimony tin oxide), electrically conductive polymers, in particular Pedot:PSS (poly(3,4-ethylenedioxythiophene), Polystyrene sulfonate), PANI (polyaniline), ITO, EDot, salts, polyacetylene, polypyrrole, polythiophene, conductive threads and other conductive material types or coatings or any combination of these. For other purposes it may also be preferred to create the electrically conductive pattern by the use of a metallic foil, e.g. such as an aluminum based cold foil. In one preferred embodiment, the electrically conductive pattern is realized by the use of two or more of the aforementioned materials.

In terms of the present invention it may be preferred to apply the electrically conductive material by a foil transfer method, preferably a hot stamping method or a thermal transfer on top of digitally printed elements and most preferably with a cold foil transfer method. For other purposes it may be preferred to manufacture the electrically conductive pattern by methods selected from a group preferably comprising additive printing methods, more preferably comprising screen printing, flexographic printing, gravure printing, intaglio, inkjet printing, pad printing and/or offset lithography, letter press and most preferably comprising flexographic printing, or any combination thereof.

In another embodiment it may be preferred to manufacture the electrically conductive pattern by the use of two or more production methods.

In further preferred embodiments the invention relates to capacitive information carriers, which are particularly suited for the method according to the invention. The invention therefore also encompasses information carriers for which the characteristics of the electrically conductive pattern are modifiable in a particular robust and predeterminable manner allowing to transmit modified information patterns based upon one physical information carrier. The design of the preferred information carriers is based upon their use in the method according to the invention. Therefore, the preferred information carriers and the preferred methods described herein are governed by the single inventive idea to allow for the provision of at least two information patterns from one information carrier, wherein a first information pattern is encoded in the information carrier prior to the modification and a second information pattern in encoded in the information carrier after the modification.

Technical features and advantages that have been disclosed for the method according to the invention and preferred embodiments thereof also apply to the preferred information carriers according to the invention. For instance, a preferred embodiment of a method according the invention encompasses an information carrier, wherein the conductive pattern is applied to the lid and/or top cover of a single-portion pack and the conductive pattern is modified by a mechanical impact upon usage of said pack in a food or beverage preparation machine. Thereby the single-portion pack, e.g. a beverage container, may be limited to a single use. Hence it is disclosed to person skilled the art that the invention also encompasses said information carrier, which can be advantageously limited to a one-time use.

A preferred embodiment of the invention encompasses a capacitive information carrier for use in a method according to the invention or preferred embodiments thereof, wherein the capacitive information carrier is a single-portion pack for a food or beverage preparation machine, wherein an electrically conductive pattern is arranged in the lid and/or top cover of the single-portion pack. It is preferred that that the single-portion pack comprises a container for the storage of a food or beverage content, e.g. a powder. Preferred such powders may be for instance coffee, espresso, milk powder, tea and/or soup powders. Said container may for instance be made of plastic, aluminum or other suitable materials. Moreover, the single-portion pack comprises preferably a lid for instance an aluminum foil, paper or a plastic lid. The electrically conductive pattern is preferably integrated into said lid or applied on top of said lid/top cover and represents a first information pattern. For the case of a non-conductive lid and/or top cover as a substrate it is preferred that the conductive pattern is made of an electrically conductive material. In case of an electrically conductive lid and/or top cover e.g. made from aluminum foil it may however also be preferred that the conductive pattern refers to a pattern formed by applying a dielectric layer on top of the aluminum foil. Said dielectric layer may preferably comprise sub-areas that add a structure to the electrically conductive layer. Due to the masking of the conductive layer only the remaining, i.e. uncovered, electrically conductive sub-areas are detected by capacitive surface sensor.

It is preferred that the preparation machine comprises suited detection means, i.e. a capacitive surface sensor, to detect the conductive pattern. It may be preferred that the machine only starts the preparation of foods or beverages if the detected information pattern corresponds to an expected information pattern stored within a data base. For example, for the preparation of an espresso it is preferred that a brewing machine comprises means to punctuate a beverage capsule comprising espresso powder to allow for a flow-through of hot water. In particular, in this process the lid and/or top cover comprising the electrically conductive pattern is punctuated which has to be understood as mechanical modification in terms of the present invention. Advantageously an unauthorized re-use of the espresso capsule with another powder can thereby be prevented. Upon attempting a second use of said capsule, the brewing machine detects either a second information pattern or no information pattern. Therefore, the preferred information carrier allows for a secure handling of a food or beverage preparation processes ensuring that only authorized, safely produced and controlled containers are used.

A further preferred embodiment of the invention encompasses a capacitive information carrier for use in a method according to the invention or preferred embodiments thereof, wherein the electrically conductive pattern comprises a predetermined breaking point. It is preferred that the electrically conductive pattern is applied on a non-conductive substrate. In the sense of the invention a “predetermined breaking point” preferably refers to a structural element of the information carrier, which is disrupted or destroyed upon usage of the information carrier. For instance, a predetermined breaking point may refer to a connecting line of an electrically conductive pattern made of a particularly bristle material. When using the information carrier, the conductive pattern is preferably disrupted at said connecting line. By using predetermined breaking points, the modification of the conductive pattern by a mechanical impact can be ensured in a particularly reliable and robust manner.

A further preferred embodiment of the invention encompasses a capacitive information carrier for use in a method according to the invention or preferred embodiments thereof, wherein the capacitive information is applied on a screw cap or a snap-on lid for a container, wherein removing the snap-on lid or the screw cap from the container leads to a disruption of the electrically conductive pattern at a predetermined breaking point. It is preferred that the conductive pattern of the information carrier is arranged in a way that opening the container disconnects the conductive pattern at the predetermined breaking point. In terms of the present invention this is be understood as modification caused by a mechanical impact and leads advantageously to a second information pattern. This allows for a particularly secure method to ensure that only unopened containers are sold which highly increases consumer security.

A further preferred embodiment of the invention encompasses a capacitive information carrier for use in a method according to the invention or preferred embodiments thereof, wherein a first part of an electrically conductive pattern is applied on a first surface of a package and connected to a second part of the electrically conductive pattern that is applied on a second surface of the package, wherein the package comprises an opening line between a first and a second surface such that the opening of the package results in a modification of the electrically conductive pattern. Preferably, the opening line of a package refers to a structural element of a package at which the surface of the package is disrupted in order to open said package. For instance, the first surface and the second surface may be two parts of a lid of a package, wherein the opening line preferably corresponds to the line between these two parts of a lid. A conductive pattern covering the opening line is therefore advantageously modified upon the opening of the package. The unmodified conductive pattern may correspond to the un-opened packaging and represents an information pattern with regard thereto, e.g. the original filling quantity etc. When the package is opened, the electrically conductive pattern preferably changes and advantageously encodes upon this modification for a second information pattern. It may be preferred that the second information pattern represents an information with regard to the opened packaging, e.g. a recipe or preparation services.

A further preferred embodiment of the invention encompasses a capacitive information carrier for use in a method according to the invention or preferred embodiments thereof, wherein the capacitive information comprises an electrically conductive pattern applied on a non-conductive substrate, wherein the electrically conductive pattern comprises a first set of sub-areas optionally connected by connecting lines made of a first conductive material and a second set of sub-areas optionally connected by connecting lines made of a second conductive material, wherein the first conductive material differs from the second conductive material in terms of tensile strength, hardness, ductility, brittleness, thermal coefficient of resistance or solubility in water. As disclosed for preferred embodiments of the method according to the invention said preferred information carrier can be advantageously modified in a particular reliable manner in order encode for a second information pattern.

### DETAILED DESCRIPTION

Without being limited to, the invention will be explained more in detail with reference to the following figures:

### BRIEF DESCRIPTION OF THE DRAWINGS

FIG. 1A: Top and side view of a preferred embodiment of an information carrier, wherein the electrically conductive pattern comprises sub-areas

FIG. 1B: Top view of a preferred embodiment of an information carrier as shown in FIG. 1A wherein the conductive pattern has been changed due to external conditions, i.e. by a mechanical impact

FIG. 10: Top view of a preferred embodiment of an information carrier as shown in FIG. 1A wherein the conductive pattern has been changed due to external conditions, i.e. by moisture

FIG. 2: Side view of a preferred embodiment of an information carrier comprising a sealing functionality, wherein the conductive pattern is arranged on a screw cap

FIG. 3: Side view of a preferred embodiment of an information carrier comprising a sealing functionality wherein the conductive pattern is arranged on a snap-on lid

FIG. 4: Preferred embodiment of an information carrier comprising two electrically conductive materials with different mechanical properties

FIG. 5A: Preferred embodiment of an information carrier with two different conductive patterns arranged on the front and top panel of a cubic object, such as a package

FIG. 5B: Preferred embodiment of an information carrier wherein a combined conductive pattern is created by unfolding a cubic object, such as a package

FIG. 6: Preferred embodiment of an information carrier comprising two contact areas

FIG. 7: Preferred embodiment of an information carrier comprising a connecting bridge

FIG. 8: Preferred embodiments of an electrically conductive pattern

### DETAILED DESCRIPTION OF THE FIGURES

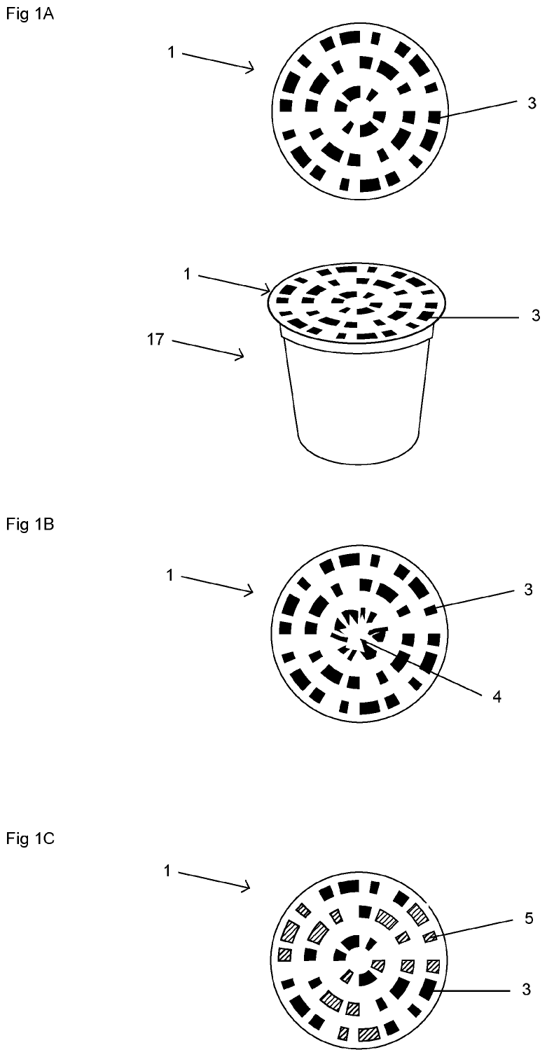

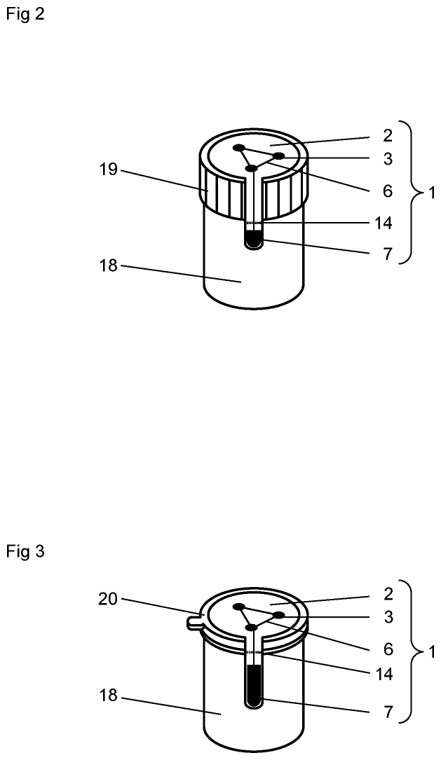

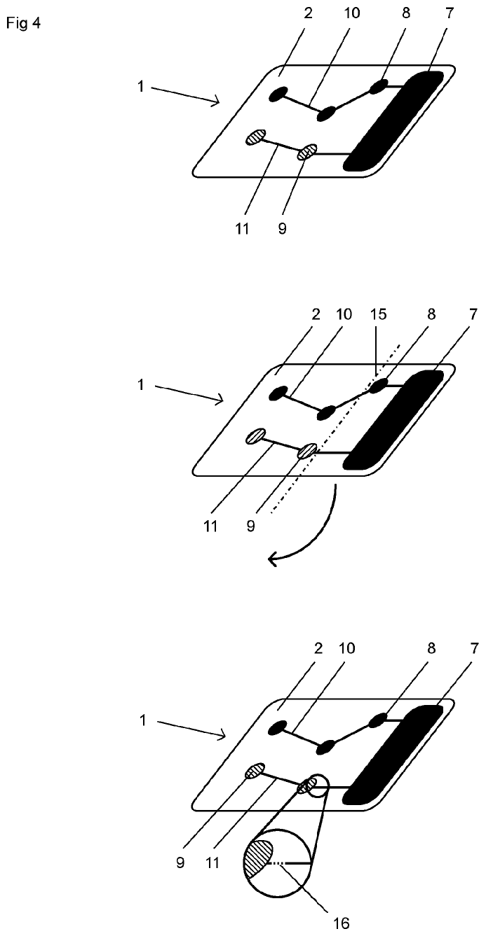

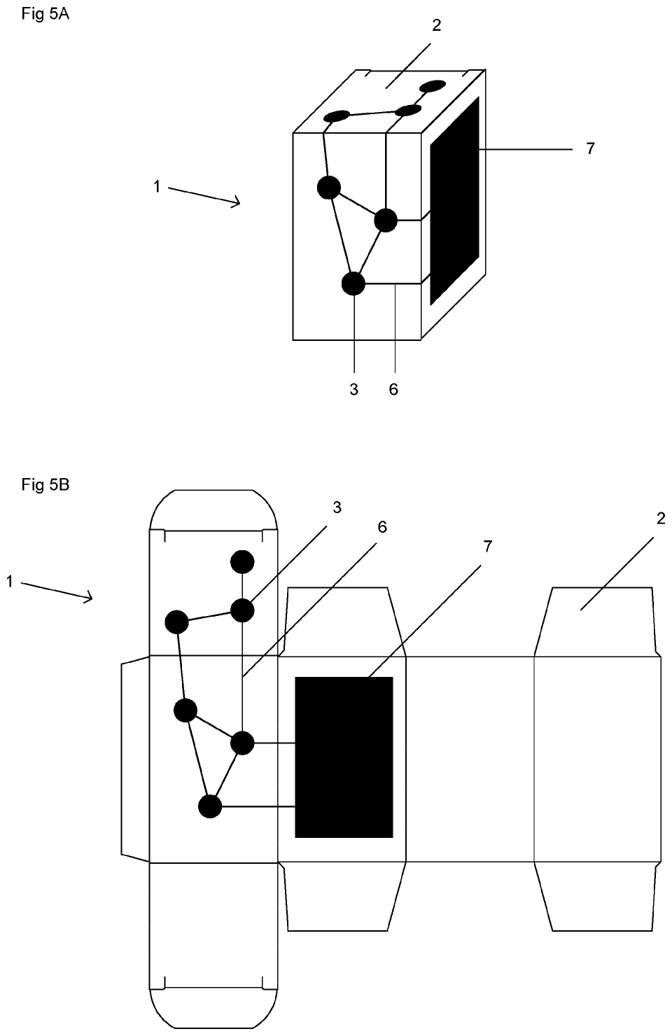

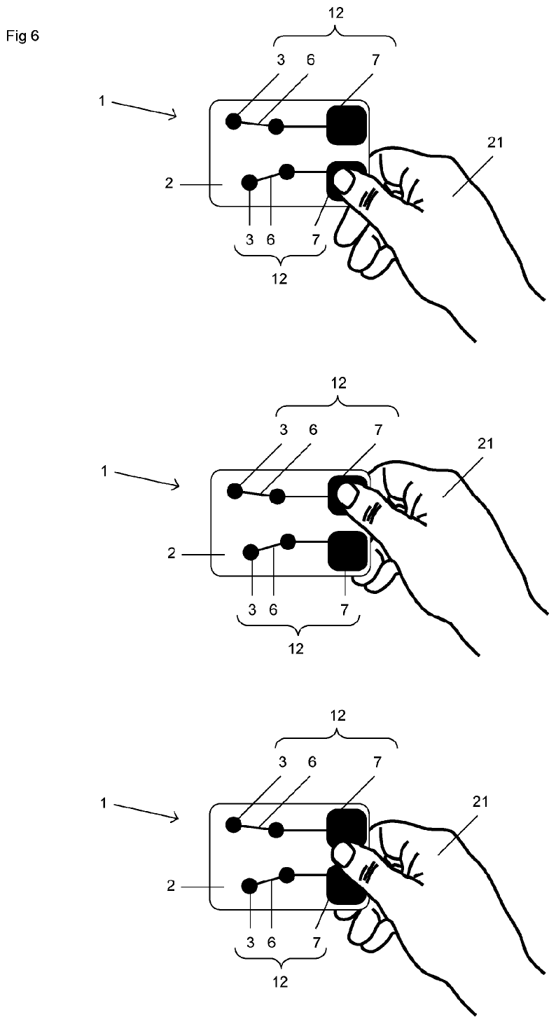

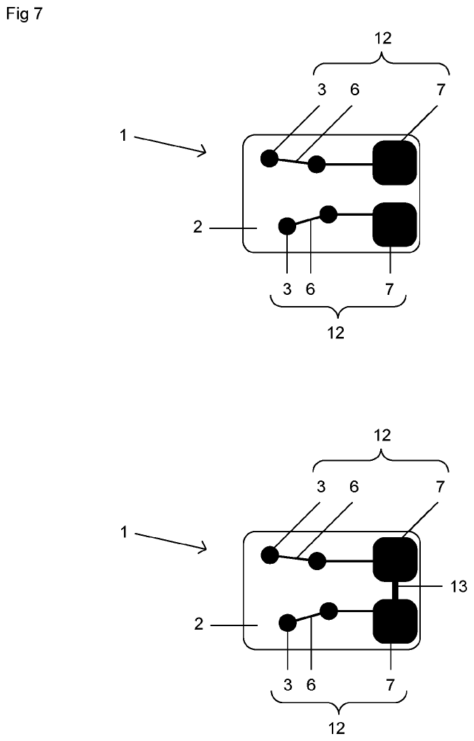

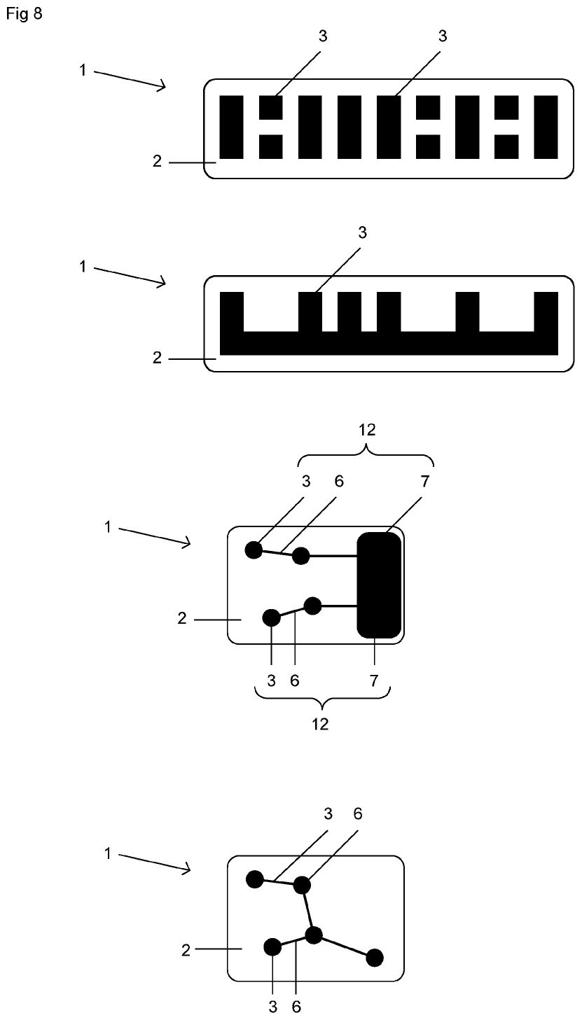

FIG. 1 shows a top and side view of a preferred embodiment of an information carrier (1), wherein the electrically conductive pattern comprises sub-areas (3). In particular, FIG. 1 shows a beverage or food container (17) which is equipped with a capacitive information carrier (1) according to a preferred embodiment of the present invention. The sub-areas (3) are distributed according to a certain conductive pattern in which information is encoded.

FIG. 1 B shows a top view of a preferred embodiment of an information carrier (1) as shown in FIG. 1 A, wherein the characteristics of the electrically conductive pattern have been changed due to an impact of an external condition. In FIG. 1 B, the modification was caused by a mechanical impact on the beverage or food container (17) comprising the information carrier (1). In particular, at least some sub-areas (4) are destroyed by the mechanical impact which is caused by the use of the beverage or food container (17) in a preparation machine. When for example the container (17) is filled with coffee powder in order to be used in a coffee machine, an information carrier (1) which is applied on top of the container (17) will be mechanically punctured by the coffee machine due to the handling of the beverage or food container (17) within the brewing machine. FIG. 1 B shows a mechanically modified conductive pattern after a container (17) comprising the information carrier (1), i.e. the electrically conductive pattern, has been used.

FIG. 1 C shows a top view of a preferred embodiment of an information carrier (1) as shown in FIG. 1 A, wherein the characteristics of the electrically conductive pattern have been modified due to an impact of an external condition. In FIG. 1 C, the change was caused by the application of moisture to the electrically conductive pattern. By the application of moisture to the electrically conductive pattern a new conductive pattern is obtained. The application of moisture may for example lead to sub-areas of the electrically conductive pattern (5) whereas the conductivity of modified sub-areas have been changed due to the impact of moisture. In the context of this preferred embodiment of the invention, it is preferred that the moisture affects either all or a just subset of sub-areas. The application of moisture to the electrically conductive pattern may occur in a food or beverage preparation machine, e.g. a brewing machine.

FIG. 2 shows a side view of a preferred embodiment of a capacitive information carrier (1) comprising a sealing functionality on a bottle with a screw cap (19). In this particular embodiment of the invention, a screw cap (19) comprises a preferred embodiment of the present invention wherein the capacitive information carrier (1) has been applied to the screw cap. e.g. by the use of label. The information carrier (1) comprises an electrically non-conductive substrate (2), an electrically conductive pattern and a predetermined breaking point (14). It is preferred that the screw cap (19) can be attached on a container (18), such as a bottle. In the context of this preferred embodiment of the invention, it is preferred that the electrically conductive pattern comprises sub-areas (3), connecting lines (6) and a contact area (7). The predetermined breaking point (14) is located between the sub-areas and connecting lines and the contact area. As soon as the screw cap (19) is removed from the container (18), the electrically conductive connection between a connecting line (6) and the contact area (7) is interrupted. Thereby, the connection between the sub-areas and the contact area is disconnected as well. Thus, the screwing off represents a modified conductive pattern by which the electrically conductive pattern is changed in the sense that the contact area (7) is separated from the sub areas (3) and connecting lines (6). By said modification, the conductive pattern can no longer be detected by a capacitive touchscreen as no external potential can be coupled in by the contact area. Due to the arrangement of the capacitive information carrier on a screw cap a user is not able to touch a sub-area directly so there is no option to couple in any external potential. By said change, the second information pattern may be preferably detected by a dedicated surface sensor but no longer on a capacitive touchscreen.

A similar preferred embodiment of the present invention is shown in FIG. 3 in which a capacitive information carrier (1) is part of a snap-on lid (20). In this preferred embodiment, an electrically conductive pattern is arranged on an electrically non-conductive substrate (2) wherein the electrically conductive pattern comprises sub-areas (3), connecting lines (6) and a contact area (7). A predetermined breaking point (14) is located between the contact area (7) and the sub-areas (3), so if the snap-on lid (20) is removed from the container (18), such as a bottle, the connecting line (6) formerly connecting a sub-area (3) to the contact area (7) is broken. In other words, the electrically conductive connection between the sub-areas (3) and the contact area (7) is interrupted. This represents a modified conductive pattern, caused by a mechanical impact, in particular by separating the electrically conductive pattern into at least two parts. Similar to the application example shown in FIG. 2, said modified conductive pattern can no longer be detected by a capacitive touchscreen, therefore no information is transmitted to the capacitive touchscreen.

The preferred embodiments of the present invention shown in FIGS. 2 and 3 may for example be used in order to detect if a container (18) was opened or not.

FIG. 4 shows a preferred embodiment of a capacitive information carrier (1) with two electrically conductive materials with different mechanical properties. In FIG. 4, an electrically conductive pattern is arranged on an electrically non-conductive substrate (2) wherein a first subset of sub-areas (8), a first subset of connecting lines (10) and the contact area (7) are formed from a first electrically conductive material, wherein the first electrically conductive material is characterized by mechanical feature A. Said electrically conductive material may be preferably chosen from a group of conductive inks which are typically very flexible. The electrically conductive pattern additionally comprises a second subset of sub-areas (9) and a second subset of connecting lines (11) which are formed from a second electrically conductive material which is characterized by mechanical feature B. The second electrically conductive material may be advantageously a conductive foil, e.g. a cold foil. Such materials are typically more sensitive to a mechanical impact, e.g. bending, rolling or folding an electrically conductive pattern. Preferably, the connecting lines (10, 11) connect either two sub-areas (8, 9) to each other or a sub-area (8, 9) to the contact area (7).

When the information carrier according to drawing 1 of FIG. 4 is brought into contact with a capacitive surface sensor, preferably with a touchscreen, the detection device will detect the entire electrically conductive pattern comprising both the first and the second subsets of sub-areas. Drawing 2 of FIG. 4 shows a creasing/folding/binding line (15) at which the information carrier according to the preferred embodiment of the invention can be creased and/or folded which preferably leads to a modified conductive pattern. It is preferred that due to the creasing and/or folding of the information carrier (1) the connecting line formed by the electrically conductive material B (11) is interrupted. As can be seen from drawing 3 of FIG. 4, the connecting line (11) between one of the sub-areas (9) and the contact area (7) is broken (16). This is due to the specific electrically conductive material of which the second subset of sub-areas (9) and connecting lines (11) are manufactured. As described above, electrically conductive materials such as foils are particularly sensitive to a mechanical impact. By folding or bending, the connecting lines formed by said material are influenced whereas sub-areas and connecting lines formed by material A will not change. It is preferred that the connecting lines formed by the second material are broken whereas the connecting lines formed by the first material are still intact. The interruption of the broken connecting line (16) preferably leads to an interruption of the electrically conductive connection between the second subset of sub-areas (9) and the contact area (7). In the context of the preferred embodiment, these sub-areas (9) can no longer be detected by the capacitive touchscreen since no external potential can be coupled in. Therefore, the interruption of the electrically conductive connection between the second subset of sub-areas (9) and the contact area (7) preferably leads to a second conductive pattern. Said second conductive pattern is represented by the first subset of sub-areas (8) which are still connected to the contact area (7), therefore enabling to couple in external potential to detect the second conductive pattern on a touchscreen.

FIG. 5 shows a preferred embodiment of an information carrier (1) with two different conductive patterns arranged on a front and a top panel of a package. In FIG. 5 A, a cubic object (without reference sign) is shown comprising a top panel and four side panels (of which two can be seen). One of the side panels comprises a subset of sub-areas (3) and a number of connecting lines (6), forming a first conductive pattern. This side panel will preferably be referred to as “front panel” of the cubic object. Two of the sub-areas (3) which are applied on the front panel of the cubic object are connected to the contact area (7) which is arranged on the side panel of the cubic object. As can be seen from FIG. 5 A, the top panel of the cubic object comprises the first conductive pattern wherein a second conductive pattern is presented on the front panel.

The cubic object which may for example represent a packaging can be brought into contact with a capacitive surface sensor, either with the top panel facing the surface of the detection means or with the front panel facing the surface of the detection means. If the top panel of the cubic object is brought into contact with a surface of the detection means, the detection means will detect the first information pattern. If the cubic object is brought into contact with a detection means with its front panel facing the surface, the detection means will recognize the second information pattern.

FIG. 5 B shows a preferred embodiment of an information carrier (1) wherein a combined additional information pattern is preferably created by unfolding the cubic object. If the former top panel and the former front panel are placed on the surface of a capacitive surface sensor, the combined electrically conductive pattern comprising six sub-areas (3) is advantageously detected as an information pattern being different to the former information patterns represent by the conductive patterns of the top and front panel. Thus, a third information pattern can be created by unfolding the cubic object, thus combining the former two electrically conductive patterns. Advantageously, a third information pattern is encoded within the cubic object by unfolding.

FIG. 6 shows a preferred embodiment of a capacitive information carrier (1) comprising two contact areas (7). A first drawing of FIG. 6 shows an electrically non-conductive substrate (2) comprising two parts (12) of an electrically conductive pattern which can advantageously be detected separately or as a combined electrically conductive pattern if an electric connection is established between the two contact areas (7).

In drawing 1 of FIG. 6, a hand (21) of a human user touches one of the two coupling areas (7) where through the lower part of the electrically conductive pattern is “activated”. In other words, the sub-areas (3) are set on the same potential as the user which makes the electrically conductive pattern detectable by a capacitive touchscreen. When the information carrier (1) is brought into contact with a touchscreen, this lower part will be detected by a touchscreen. The upper part of the electrically conductive pattern will advantageously not be detected as the contact area (7) is not touched by a human user and thus not “activated”.

In drawing 2 of FIG. 6, the upper coupling area (7) of the electrically conductive pattern is touched by a hand (21) of a human user. It is preferred that by this touch, the upper part of the electrically conductive pattern is “activated”, i.e. the upper part of the electrically conductive pattern can be detected.

In drawing 3 of FIG. 6 the thump of the hand (21) of a human user is arranged so that both contact areas (7) are touched by the human user and thus “activated”. By touching both contact areas (7), the upper part of the electrically conductive pattern and the lower part of the electrically conductive pattern can be detected. Advantageously, a combined third electrically conductive pattern which is different from the upper part of the electrically conductive pattern and from the lower part of the electrically conductive pattern is created. As can be seen from the three drawings of FIG. 6, three different electrically conductive patterns can be detected so three information patterns are preferably encoded.

FIG. 7 shows a preferred embodiment of a capacitive information carrier (1) comprising a connector bridge (13). The connector bridge (13) can also be referred to as connecting bridge. The first drawing of FIG. 7 shows an information carrier (1) which is identical to the information carrier (1) of FIG. 6. The inventors of the present invention have found that a third electrically conductive pattern can be created by connecting the two contact areas (7) of the information carrier (1) by a connecting bridge (13). This connecting bridge (13) serves the same purpose as the finger of the human user in the preferred embodiment described in FIG. 6, i.e. the connecting bridge (13) establishes an electric connection between the two coupling areas (7).

Thus, three different information patterns can be detected, namely the upper part, the lower part and the third electrically conductive pattern representing the combination of the latter two electrically conductive patterns. Advantageously, three different information patterns may be encoded. It is noted that the application of the connecting bridge (13) represents a modification of the information pattern caused by addition of conductive material in the sense of the present invention.

FIG. 8 presents four preferred embodiments of a capacitive information carrier (1). In the first drawing a capacitive information carrier is shown that comprises several sub-areas (3) that are not connected among each other. As can be seen, sub-areas (3) are formed differently. In the second drawing of FIG. 8, a conductive pattern is formed by one sub-area (3) whereas the sub-area is formed as free-hand form.

Preferably, the capacitive information carriers (1) as seen in the first and second drawing are detected by a dedicated reading device. In the third drawing of FIG. 8 a capacitive information carrier (1) is shown which connects sub-areas (3) by the use of a connecting line (6) to the contact area (7). By said layout the information pattern can be detected by a capacitive multitouch screen, integrated into devices such as a smartphone or tablet. The last drawing of FIG. 8 shows a capacitive information carrier (1) whereas the sub-areas (3) are connected to each other by the use of connecting lines (6). To be detected on a multitouch screen, a conductive potential needs to be applied. Therefore, one sub-area needs to be touched as soon as the capacitive information carrier (1) will be in a close contact with a touch-screen. By said embodiment, the entire conductive pattern will be set on the same potential as the conductive object which makes the conductive pattern detectable for a multi-touch screen device.

It should be understood that various alternatives to the embodiments of the invention described herein may be employed in practicing the invention. It is intended that the following claims define the scope of the invention and that the method and information carrier within the scope of these claims and their equivalents be covered thereby.

### REFERENCE NUMBERS

1 capacitive information carrier
2 electrically non-conductive substrate or base material
3 electrically conductive sub-area of a conductive pattern
4 electrically conductive sub-area affected by a mechanical input
5 electrically conductive sub-area affected by moisture
6 connecting line
7 contact area
8 sub-area (1^{st} material)
9 sub-area (2^{nd} material)
10 connecting line (1^{st} material)
11 connecting line (2^{nd} material)
12 electrically conductive pattern comprising sub-areas, connecting lines and a contact area
13 connecting bridge
14 predetermined breaking point
15 creasing/folding/bending line
16 broken connecting line
17 food or beverage container
18 container
19 screw cap
20 snap-on lid
21 hand

1. (canceled)

2. A method for transmitting information from a capacitive information carrier to a capacitive surface sensor comprising:
a) providing the capacitive surface sensor,
b) providing the capacitive information carrier wherein a first information pattern is encoded within the characteristics of an electrically conductive pattern,
c) modifying the characteristics of the electrically conductive pattern due to external conditions to encode a second information pattern on the capacitive information carrier, and
d) bringing the capacitive information carrier into contact with the capacitive surface sensor wherein the second information pattern is capacitively detected by the capacitive surface sensor.

3. The method according to claim 2, wherein the capacitive information carrier comprises the electrically conductive pattern applied on a non-conductive substrate.

4. The method according to claim 2, wherein the characteristics of the electrically conductive pattern are modified by external conditions selected from a group consisting of a mechanical impact, an electric impact, an electromagnetic impact, a magnetic impact, an environmental impact, a chemical impact and an addition of an electrically conductive material.

5. The method according to claim 4, wherein the characteristics of the electrically conductive pattern are modified by a mechanical impact comprising at least one of abrasion, scratching, separating, cutting, perforation, punching, velocity, acceleration, shock, physical tampering and a pressure change.

6. The method according to claim 4, wherein the characteristics of the electrically conductive pattern are modified by at least one of laser radiation, electromagnetic radiation, ultraviolet (UV) radiation, infrared (IR) radiation, radiofrequency (RF) radiation, microwave radiation, the application of electrostatic fields and the application of electrodynamic fields.

7. The method according to claim 4, wherein the characteristics of the electrically conductive pattern are modified by an environmental impact comprising a change in at least one of temperature, humidity and moisture.

8. The method according to claim 4, wherein the characteristics of the electrically conductive pattern are modified by a chemical impact comprising chemical reactions of the conductive pattern with an acidic solution or an alkaline solution.

9. The method according to claim 4, wherein the characteristics of the electrically conductive pattern are modified by an addition of an electrically conductive material, selected from a group of conductive colors, pencils, conductive bridges, inks and foils.

10. The method according to claim 2, wherein the characteristics of the electrically conductive pattern are modified by a combination of at least two external conditions selected from a group consisting of a mechanical impact, an electric impact, an electromagnetic impact, a magnetic impact, an environmental impact, a chemical impact and an addition of an electrically conductive material.

11. The method according to claim 2, wherein the electrically conductive pattern comprises at least two different conductive materials.

12. The method according to claim 11, wherein said at least two different conductive materials differ in terms of tensile strength, hardness, ductility, brittleness, thermal coefficient of resistance or solubility in water.

13. The method according to claim 2, wherein the electrically conductive pattern is formed by at least one sub-area limited by an outline and wherein the information is encoded within at least one of shape, size, arrangement and geometry of the electrically conductive pattern.

14. The method according to claim 2, wherein the electrically conductive pattern is detected by capacitive surface sensors comprising at least one of capacitive touchscreens and touchpads.

15. The method according to claim 2, wherein the modification of the characteristics of the electrically conductive pattern activates a new conductive pattern, deactivates at least a part of the conductive pattern or destroys a conductive pattern completely.
